(19) United States
(12) Patent Application Publication
(10) Pub. No.: US 2025/0349983 A1
(43) Pub. Date: Nov. 13, 2025

(54) IN-PLANE FLEXIBLE ELECTRICAL BUSBAR

(71) Applicant: Manaflex, LLC, Waikoloa, HI (US)

(72) Inventors: Augusto E. BARTON, Pinecrest, FL (US); Robert C. LANE, Las Vegas, NV (US); Yifei LIU, Toronto (CA)

(21) Appl. No.: 19/193,131

(22) Filed: Apr. 29, 2025

Related U.S. Application Data
(60) Provisional application No. 63/640,703, filed on Apr. 30, 2024.

(51) Int. Cl. H01M 50/503; H01B 5/02; H01M 50/522

(52) U.S. Cl. CPC H01M 50/503; H01B 5/02; H01M 50/522

(57) ABSTRACT

A multi-layer metal bar and a flexible metal bar. The flexible metal bar comprises a plurality of connection bars for connecting the positive or negative electrode of the battery cell and a plurality of connection bars connected between the adjacent connection bars, and an interval between the adjacent connection bars is arranged. It has the advantages of simple structure, the adjacent connecting bars are connected by connecting bars, and the connecting bars arranged at intervals form a spring-like effect, allowing elongation and compression. When the cell expands, the flexible connection between the adjacent connecting bars is not easy to be accomplished, and the electrical conductivity of the flexible metal bars can still be ensured.

### CROSS-REFERENCE TO RELATED APPLICATION

This application is a non-provisional application of, and claims priority to and the benefit of, U.S. Provisional Patent App. No. 63/640,703, entitled “In-Plane Flexible Electrical Busbar”, filed Apr. 30, 2024, with Attorney Docket No. 4375.0017P, the entire disclosure of which is incorporated by reference herein in its entirety.

### FIELD OF INVENTION

The present invention relates to the technical field of a new energy battery, in particular to a multi-layer metal bar and a flexible metal bar thereof.

### BACKGROUND

During the usage of the battery pack, with the declining in the state of health of the battery/cell, the middle part of the battery will gradually expand, the battery is centrally set in the bus composed of aluminum bars, and the battery expansion force is usually large, although the gap between the battery and the battery is generally left for expansion, but at the end of the battery life, the gap between the batteries will still increase. The aluminum bar will be stretched or even broken, causing the aluminum bar to fail to conduct current, affecting the connection between the aluminum bar and the battery electrode. Therefore, improvements need to be made.

### SUMMARY

The present invention discloses a flexible metal strip, comprising a plurality of connection strips for connecting the positive or negative electrodes of the battery core and a plurality of connecting bars connected between adjacent connection strips, with gaps set between adjacent connecting bars.

Furthermore, in the flexible metal strip mentioned above, the connecting bars are integrally formed with the connection strips and grooves are provided between adjacent connecting bars.

Furthermore, in the flexible metal strip mentioned above, the grooves are arc-shaped, curved, polygonal, straight, or sinusoidal along their length.

Furthermore, in the flexible metal strip mentioned above, the dimensions and shapes of the grooves may be the same or different.

Furthermore, in the flexible metal strip mentioned above, the connecting bars and the connection strips are separate structures, and the two ends of the connecting bars are electrically connected to the corresponding connection strips.

Furthermore, in the flexible metal strip mentioned above, the connecting bars are arc-shaped, curved, polygonal, straight, or sinusoidal along their length.

Furthermore, in the flexible metal strip mentioned above, the dimensions and shapes of the connecting bars may be the same or different.

The present invention also discloses a multi-layer metal strip composed of the aforementioned flexible metal strip layers.

Compared with the prior art, the present invention has the following advantages: the structure of the present invention is simple, with connecting bars connecting adjacent connection strips and allowing for stretching and compression due to the spring-like effect formed by the spaced connecting bars, enabling flexible connection between adjacent connection strips when the battery core expands, thereby preventing easy breakage and ensuring the conductivity of the flexible metal strip; the multi-layer metal strip formed by stacking flexible metal strips enhances the elasticity at the connecting bar locations.

### BRIEF DESCRIPTION OF THE DRAWINGS

To further illustrate the embodiments or technical solutions in the present invention, a brief introduction of the drawings required in the description of the embodiments or prior art will be provided below. It is evident that the drawings described below are only some embodiments recorded in the present invention, and ordinary skilled artisans in this field can obtain other drawings based on these drawings without creative labor.

FIG. 1 shows a schematic diagram of the first structure of the flexible metal strip in a specific embodiment of the present invention.

FIG. 2 shows a schematic diagram of the second structure of the flexible metal strip in a specific embodiment of the present invention.

FIG. 3 shows a schematic diagram of the third structure of the flexible metal strip in a specific embodiment of the present invention.

FIG. 4 shows a schematic diagram of the fourth structure of the flexible metal strip in a specific embodiment of the present invention.

FIG. 5 shows a schematic diagram of the fifth structure of the flexible metal strip in a specific embodiment of the present invention.

FIG. 6 shows a schematic diagram of the structure of the multi-layer metal strip in a specific embodiment of the present invention.

Like reference numerals have been used to identify like elements throughout this disclosure.

### DETAILED DESCRIPTION

Below, with reference to the drawings in the embodiments of the present invention, a detailed description of the technical solutions in the embodiments of the present invention will be provided. Obviously, the described embodiments are only a part of the embodiments of the present invention, not all embodiments. Based on the embodiments in the present invention, all other embodiments obtained by ordinary skilled artisans in this field without creative labor belong to the scope of protection of the present invention.

In the description of the present invention, it should be noted that terms such as “center”, “top”, “bottom”, “left”, “right”, “vertical”, “horizontal”, “inner”, “outer”, etc., indicating directions or positional relationships, are based on the orientations or positional relationships shown in the drawings, solely for facilitating the description of the present invention and simplifying the description, rather than indicating or implying that the devices or components referred to must have specific orientations, be constructed and operated in specific orientations, and therefore cannot be construed as limiting the present invention. In addition, terms such as “first”, “second”, “third” are used for descriptive purposes only and cannot be construed as indicating or implying relative importance.

In the description of the present invention, it should be noted that unless otherwise expressly specified and limited, terms such as “installation”, “connection”, “joining” should be broadly interpreted. For example, they can be fixed connections, detachable connections, or integral connections; they can be mechanical connections or electrical connections; they can be directly connected or indirectly connected through intermediate media, and they can be connections within two components. Ordinary skilled artisans in this field can understand the specific meanings of the above terms in the present invention according to specific situations.

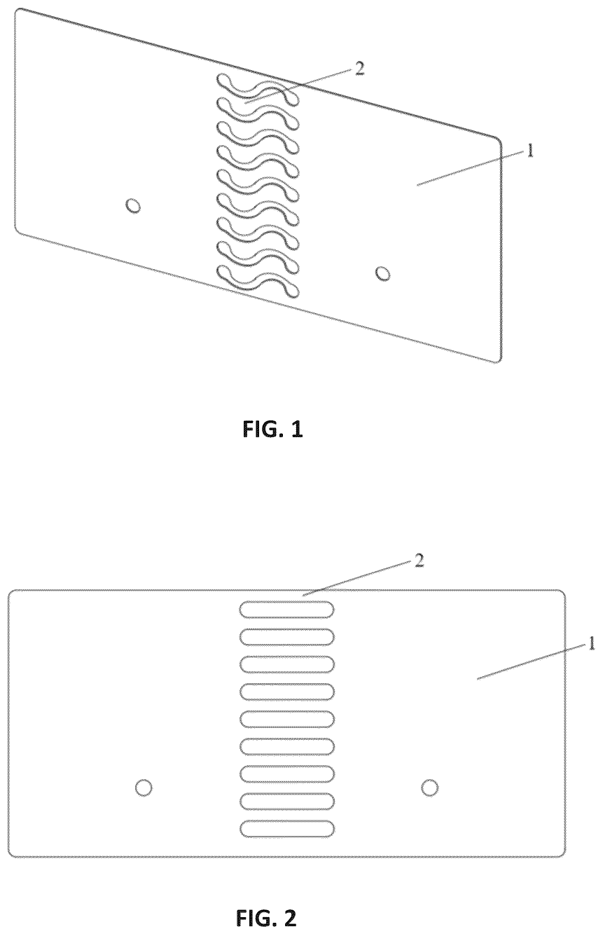

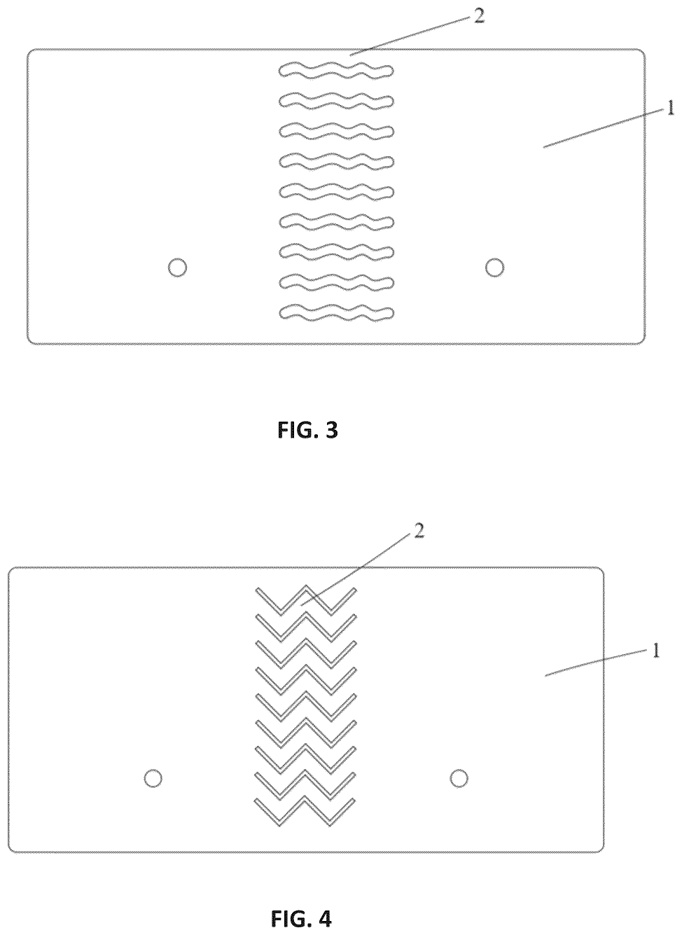

Exemplarily, referring to FIGS. 1 to 5, a flexible metal strip comprises several connection strips 1 for connecting the positive or negative electrodes of the battery core and several connecting bars 2 connected between adjacent connection strips 1, with intervals set between adjacent connecting bars 2.

In this technical solution, the connection strips are made of any electrically conductive materials, including but not limited to aluminum, copper, steel, nickel, as well as composite materials and various alloys. In some embodiments, layers of the same or different material types can be used together. The connection strips are provided with connection positions for connecting the positive or negative electrodes of the battery core. The connection strips between adjacent batteries are connected by several connecting bars with intervals set, forming a spring-like effect, allowing for elongation and compression. When the battery core expands, the corresponding flexible connection between adjacent connection strips is not easily broken, ensuring the conductivity of the flexible metal strip. Additionally, the connecting bars can also be used as fuses to fuse when the current exceeds a set value, protecting the battery. When used as a fuse, the gaps between the connection rows are filled with injection-molded insulating and flame-retardant sealing agents or potting compounds to encapsulate the fuse wire, preventing the occurrence of electric sparks.

Exemplarily, referring to FIGS. 1 to 4, the connecting bars 2 are integrally formed with the connection strips 1 and grooves are set between adjacent connecting bars 2.

In this technical solution, adjacent connection strips are made of the same aluminum plate/foil, with several grooves hollowed out between adjacent battery connection positions, and the remaining portions between adjacent grooves form connecting bars. The connecting bars with intervals set form a spring-like effect, allowing for elongation and compression. When the battery core expands, the corresponding flexible connection between adjacent connection strips is not easily broken, ensuring the conductivity of the flexible metal strip.

Exemplarily, referring to FIGS. 1 to 4, the grooves are arc-shaped, curved, polygonal, straight, or sinusoidal along their length, and the dimensions and shapes of the grooves may be the same or different.

In this technical solution, the grooves can have regular or irregular shapes, such as arc-shaped, curved, polygonal, straight, and sinusoidal, etc. The grooves can be a single structure or a mixture of two or more structures, and the dimensions of the grooves can be the same or different, as long as they can achieve flexible connection between the connection strips. The entire flexible metal strip uses relatively thin materials, which can be produced using coil aluminum sheets, combined with existing rotary blades or laser cutting machines for streamlined production, resulting in high production efficiency. Additionally, due to its characteristics of being producible on fully automated production lines, subsequent processes such as additional insulation layer can be executed fully automatically, saving labor costs and further improving production efficiency.

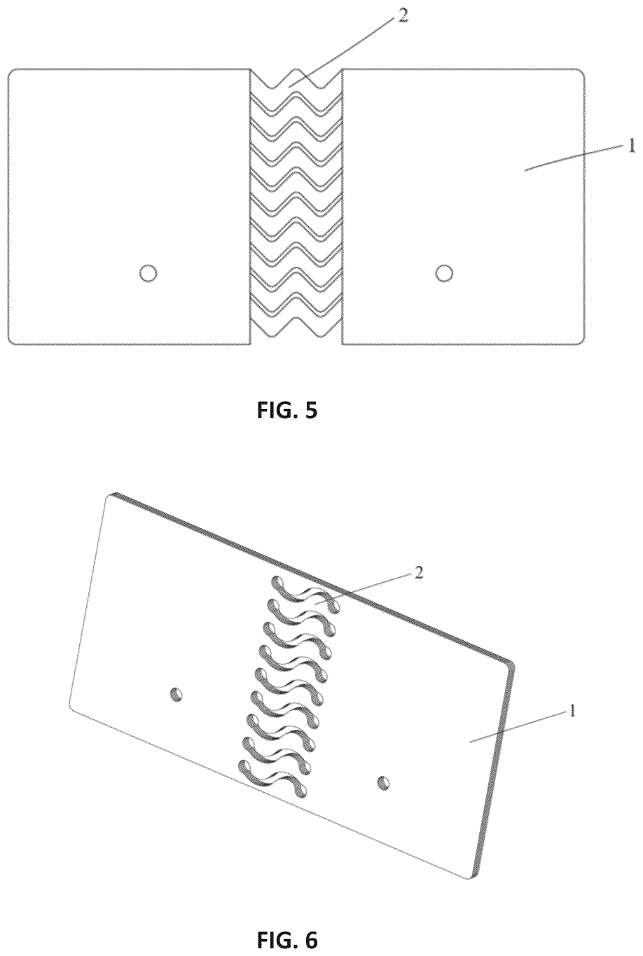

Exemplarily, referring to FIG. 5, the connecting bars 2 are separate structures from the connection strips 1, and the two ends of the connecting bars 2 are electrically connected to the corresponding connection strips 1. The connecting bars 2 are arc-shaped, curved, polygonal, straight, or sinusoidal along their length, and the dimensions and shapes of the connecting bars may be the same or different.

In this technical solution, the two ends of the connecting bars are respectively connected to the corresponding connection strips by conventional methods such as welding, and are electrically connected to the connection strips. The connecting bars with intervals set can achieve flexible connection between adjacent connection strips. The shape and size of the connecting bars are not required, as long as flexible connection between adjacent connection strips can be achieved.

Exemplarily, referring to FIG. 6, a multi-layer metal strip is composed of multiple layers of the aforementioned flexible metal strip to strengthen the overall strength and elasticity at the locations of the connecting bars, with overlapping or staggered arrangement of connecting bars within adjacent flexible metal strips.

In summary, the present invention has a simple structure, with connecting bars connecting adjacent connection strips and forming a spring-like effect with intervals set, allowing for elongation and compression. When the battery core expands, the corresponding flexible connection between adjacent connection strips is not easily broken, ensuring the conductivity of the flexible metal strip. The multi-layer metal strip formed by stacking flexible metal strips enhances the elasticity at the locations of the connecting bars. The entire strip uses relatively thin materials, which can be produced efficiently using coil aluminum sheets combined with existing rotary blades or laser cutting machines on production lines. Additionally, due to its characteristics of being producible on fully automated production lines, subsequent processes such as additional insulation layer can be executed fully automatically, saving labor costs and further improving production efficiency.

It should be noted that in this document, the terms “comprising”, “including”, or any other variants thereof, are intended to encompass non-exclusive inclusion, so that processes, methods, articles, or devices comprising a series of elements include not only those elements explicitly listed, but also other elements not explicitly listed, or even elements inherent to such processes, methods, articles, or devices. In the absence of further limitations, the elements limited by the phrase “including one . . . ” do not exclude other identical elements in processes, methods, articles, or devices including the specified elements.

What is claimed is:

1. A flexible metal bar comprising: a plurality of connection bars for connecting a positive or negative electrode of a battery cell and a plurality of connection bars connected between adjacent connection bars, and an interval between the adjacent connection bars is arranged.

2. The flexible metal bar of claim 1, wherein the connecting strip is made as one with the connecting strip, and a groove is arranged between the adjacent connecting strips.

3. The flexible metal bar of claim 2, wherein the through groove along its length direction is arc shaped or curve shaped or broken line shaped or linear or wavy line structure.

4. The flexible metal bar of claim 2, wherein the size and shape of the grooves are the same or different.

5. The flexible metal bar of claim 1, wherein the connection bar and the connection bar are split structure, and the two ends of the connection bar are electrically connected to the corresponding connection bar.

6. The flexible metal bar of claim 5, wherein the connection bar has a curved or curved or broken line or linear or wavy line structure along its length direction.

7. The flexible metal bar of claim 5, wherein the size and shape of the connection strip are the same or different.

8. A multi-layer metal bar, which is characterized in that it includes the flexible metal bar of claim 1.

9. A multi-layer metal bar, which is characterized in that it includes the flexible metal bar of claim 2.

10. A multi-layer metal bar, which is characterized in that it includes the flexible metal bar of claim 3.

11. A multi-layer metal bar, which is characterized in that it includes the flexible metal bar of claim 4.

12. A multi-layer metal bar, which is characterized in that it includes the flexible metal bar of claim 5.

13. A multi-layer metal bar, which is characterized in that it includes the flexible metal bar of claim 6.

14. A multi-layer metal bar, which is characterized in that it includes the flexible metal bar of claim 7.
